(19) United States
(12) Patent Application Publication
(10) Pub. No.: US 2001/0047395 A1
(43) Pub. Date: Nov. 29, 2001

(54) Linking to a service by mapping an internet-independent unique identifier to a stored program

(76) Inventor: Kehyeh Szutu, Palo Alto, CA (US)

Correspondence Address: Bo-In Lin, 13445 Mandoli Drive, Los Altos Hills, CA, 94022, US

(21) Appl. No.: 09/771,484

(22) Filed: Jan. 25, 2001

Related U.S. Application Data
(60) Provisional application No. 60/177,960, filed on Jan. 25, 2000.

(51) Int. Cl. G06F 15/16

(52) U.S. Cl. 709/217; 709/245

(57) ABSTRACT

The present invention discloses network system. The network system includes a network resource management center comprises a database for storing paired data for linking a network-independent preexisting-unique identifier to a network resource locator. In a preferred embodiment, the network resource management center further comprises a network-resource request-input processor for processing a network-resource request input comprises information related to the network-independent preexisting-unique identifier for searching the database for providing a linked URL stored in the database. In a preferred embodiment, the network resource management center further comprises a network-resource registration processor for receiving a registration request comprises a network-independent preexisting-unique identifier and an associated network resource locator for storing in the database. In a preferred embodiment, the network-resource request-input processor further comprises a network-resource request-input normalizing means for normalizing and converting a network-resource request-input into a normalized network-resource request. In a preferred embodiment, the network-resource request-input processor further comprises a first sub-domain processing means for receiving and processing a network-resource request-input constituting a first sub-domain name under an Internet domain name of the network resource management center. In a preferred embodiment, the network system further comprises an universal resource locator forward means for forwarding an universal resource locator retrieved from the database to a network resource requester.

This Application claims a Priority Date of Jan. 25, 2000, benefited from a previously filed Provisional Application No. 60/177,960 filed on Jan. 25, 2000 by the same Applicant of this Patent Application.

### BACKGROUND OF THE INVENTION

1. Field of the Invention

This invention relates generally to a network system for linking to different network addresses or server Web sites. More particularly, this invention relates to an improved system configuration and method for interactively linking a network-independent unique identifier, typically a preexisting unique identifier, to a network resource. The network resource may include an Internet web page or web site managed by a networked server or other resources such as mail or URI (Uniform Resource Identifier).

2. Description of the Prior Art

As more Internet domain names are registered and owned by registrants, the task of either registering an unique domain name or linking to an Internet Web site or Web page become more inconvenient. There are several reasons for the present difficulties. The first difficulty is the rapidly reduced availability of the short, memorable and unique domain names as more registrants are applying for their unique domain names. The second difficulty is the requirement to type in long identifier with a stringent requirement of typing every letter and number correctly for linking and accessing a Web site or Web page. These difficulties are particularly pronounced for some small business owners because their limited resources and inability to secure an unique name related to their business earlier enough.

Therefore, a need still exists in the art of network data communication and resource management in locating and linking to different network resource to provide a new and improved configuration and method to overcome these limitations. The improved configuration and method must enable a network resource owner to interactively access and editing a database of a network resource management center. By making use of the database, universal resource locator (URL) is linked with network independent identifier such that the difficulties in obtaining a short, memorable and unique domain name would not prevent an Internet user to unique identify and link to the network resource. Convenient and simple method of linking and using network resources identified by network-independent unique identifier can be realized without being limited by the difficulties confronted by the Internet system as of now.

### SUMMARY OF THE PRESENT INVENTION

It is therefore an object of the present invention to provide a system configuration and method to enable a network resource owner to interactively access and editing a database for linking a universal resource locator to an Internet-independent unique identifier. By providing such linking, a person of ordinary skill in the art is enabled to overcome the aforementioned difficulties and limitations encountered in the prior art.

Specifically, it is an object of the present invention to provide a new method and system configuration by providing a network resource management center provided with database accessible by a network resource owner through a registration process. The network resource management center further included a network-resource request processor to process a network-resource request-input by normalizing and linking a request-input with a network-resource location pointer to link an Internet independent identifier with a Web site or Web page. An Internet-independent preexisting identifier such as a telephone number can be easily employed for linking to the Web resource owned by the telephone number owner. The difficulties in attempting to register a short, memorable and unique Internet domain name or to link through long names consisted of long and strange combinations of alphanumeric characters are resolved.

Another object of the present invention is to provide a new method and system configuration by providing a network resource management center provided with database accessible and editable by a network resource owner through a registration and updating process. The network resource management center further included a network-resource request-input normalizing processor to normalize a network-resource request-input. The normalization process is to relief the burden of an internet user from a requirement of typing in the Internet-independent unique identifier, such as a telephone number or a branch name, with exact alphanumeric characters arranged in specific sequential order without any tolerance of entry errors.

Another object of the present invention is to provide new method and system configuration by providing a network resource management center provided with first-level sub-domain processor to process the first level sub-domain name, e.g. the part of URI that follows the TLD (top level domain) name. One example of the first-level sub-domain in the case of access by UR is the name following the top level domain (TLD) name of the network resource management center. Another example is for electronic mail (e-mail) application, the user name before the @ sign. The first level sub-domain name is then applied as an Internet-independent unique identifier provided through a network-resource request-input. A simple and convenient method is provided that allows an Internet user to input a linking request related the Internet independent unique identifier. Such identifiers may be a phone number or a promotion number. A linking request is sent without requiring to go through several navigation steps or layers of Web site links achievable only through typing long list of names, e.g., URIs or email addresses.

Briefly, in a preferred embodiment, the present invention discloses network system. The network system includes a network resource management center comprises a database for storing paired data for linking a network-independent preexisting-unique identifier to a network resource locator. In a preferred embodiment, the network resource management center further comprises a network-resource request-input processor for processing a network-resource request input comprises information related to the network-independent preexisting-unique identifier for searching the database for providing a linked URL stored in the database. In a preferred embodiment, the network resource management center further comprises a network-resource registration processor for receiving a registration request comprises a network-independent preexisting-unique identifier and an associated network resource locator for storing in the database. In a preferred embodiment, the network-resource request-input processor further comprises a network-resource request-input normalizing means for normalizing and converting a network-resource request-input into a normalized network-resource request. In a preferred embodiment, the network-resource request-input processor further comprises a first sub-domain processing means for receiving and processing a network-resource request-input constituting a first sub-domain name together with an Internet domain name of the network resource management center. In a preferred embodiment, the network system further comprises an universal resource locator forward means for forwarding an universal resource locator retrieved from the database to a network resource requester.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 shows a functional block diagrams for illustrating a new configuration of a network communication system provided with network resource management center on the Internet of this invention;

FIG. 2 shows a functional block diagram of a registration process for resource registration and building up a network resource database.

FIG. 3 is a functional block diagram of a network resource management center implementation under the mobile phone environment.

FIG. 4 shows a preferred embodiment in implementing the database system.

### DETAILED DESCRIPTION OF THE PREFERRED EMBODIMENT

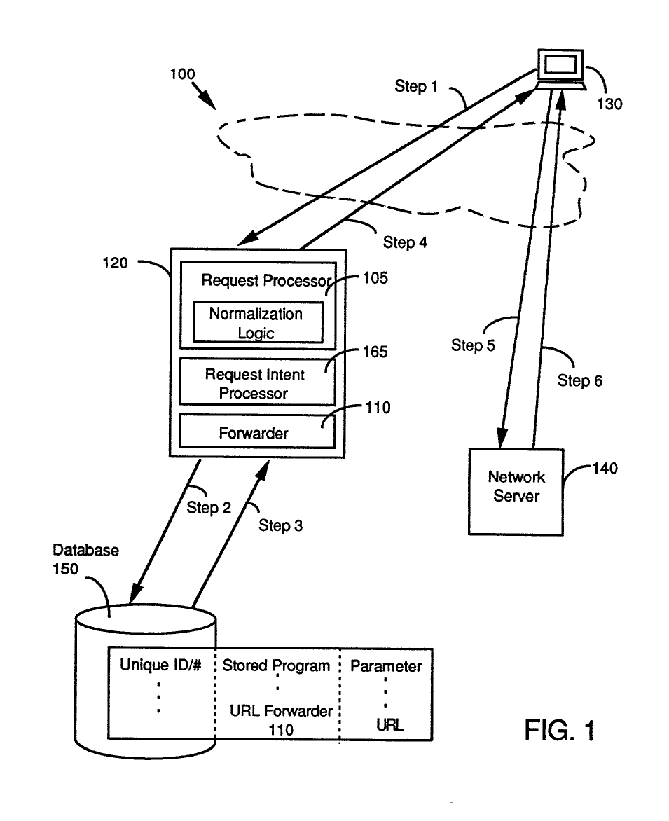

Referring to FIG. 1 for a functional block diagram according to one implementation of the present invention. The network communication system, e.g., an Internet system 100, includes a network resource management center 120. In one of the preferred embodiments, this network resource management center 120 is implemented to support HTTP as an Internet control Web server. The network resource management center 120 is connected to and in communication with a network resource requester 130, using a web browser, to receive a network resource request input, i.e., step (1). One type of network-resource request may be a request for linking to another network-resource, e.g., a Web page on an Internet web server 140, this request from requester 130 comes in as a Hypertext Transfer Protocol (HTTP) command. The network resource management center 120 includes a network resource request processor 105 and a request-intent processor 165; a request-intent processor calls upon different stored programs to carry out the intent of the resource request. In one implementation of the present invention, the request-intent processor may invoke a stored program which is a network resource URL forwarder 110. The network-resource requester 130 sends a network-resource request-input to the network resource management center 120. The network-resource request-input may be an HTTP command input preferably includes an Internet-independent preexisting unique identifier to identify and link to a web page on Internet server 140. This Internet independent preexisting unique identifier is preferably a unique number that is provided and governed by an Internet-independent administrative authority, e.g., a telephone number, a social security number, a tax identification number, a driver's license number, etc. The requested web page on Web server 140 preferably has a unique association with the Internet-independent preexisting unique identifier, e.g., when a phone number is used as the unique identifier that telephone number is the number of the owner of that requested Web page on web server 140. The description is only used to illustrate one of the implementation and is not intended to limit the present invention. An ownership of the resource/web page as described above even though is desirable but not required. The unique number can be associated with any stored programs or any web resource. The resource request processor 105 further includes a request-input normalization logic that could be implemented as software or a hardware component of the network-resource request processor 105. After the network resource management center 120 receives the network-resource request-input, the network-resource request processor 105 performs a normalization to convert the request-input into a normalized network resource request. Then the network resource request processor 105 accesses a network resource database 150, i.e., step (2), to perform a database search to match the normalized network-resource request with a stored procedure. The normalization process can also be implemented as part of the exception handling process when a match in the database can not be found after a search is performed. When a stored procedure, e.g., forwarding an URL, is matched with the normalized network-resource request, i.e., step (3), the stored program is executed and the matched URL is forwarded to the network-resource requester 130, i.e. step (4). Using that matched URL, the network-resource requester 130 is linked to the web page on web server 140, i.e., steps (5) and (6), that can be associated and identified by the network-resource request-input that is uniquely designated with an Internet-independent preexisting identifier such as a telephone number.

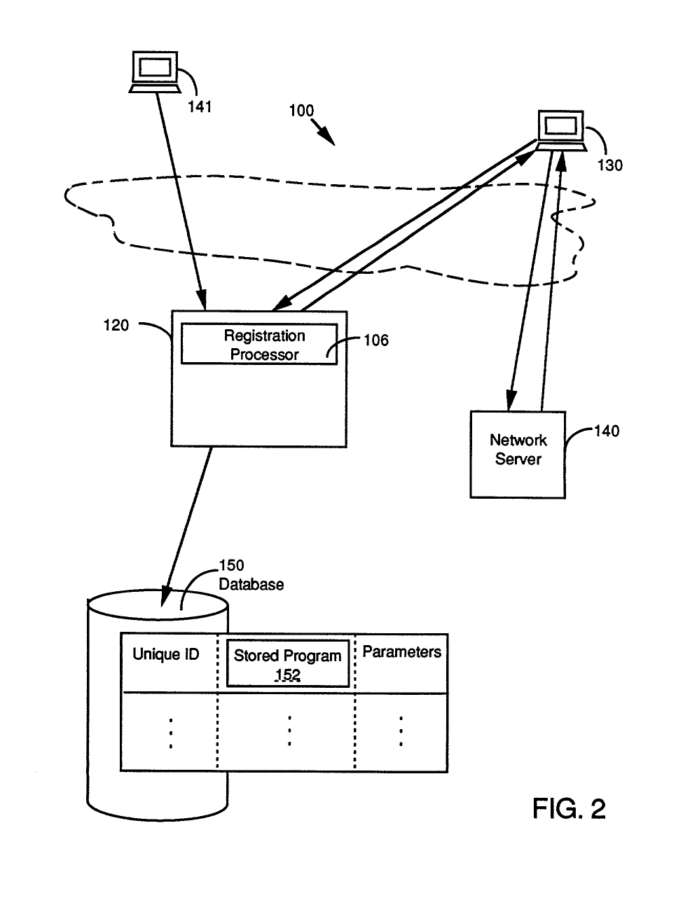

FIG. 2 is a functional block diagram of a registration process for network resources registration and building up a network resource database 150. The network resource management center 120 includes a network resource registration processor 106 and a network resource database 150. In one implementation of the present invention, this registered resource may be a service for forwarding the incoming request to another uniform resource locator (URL). To register with the network management center 120, a register 141 of an internet-independent, preexisting, unique identifier may first log on to the Web page managed by a registration processor 106 of the network resource management center 120. The register 141 then provides an Internet-independent preexisting-unique identifier and an associated universal resource locator (URL) to the registration processor 106 of the network resource management center 120. After the registration processor 106 receives the Internet-independent unique identifier that preferably is a preexisting identifier such as a telephone number and the associated universal resource locator (URL), the network resource management center 120 store the preexisting unique identifier paired with the URL provided by the registrant 141. With these pairs stored in the database 150, pointers are stored for linking the Internet-independent preexisting-identifier to the URL stored in the database 150 as associated pairs. Those skilled in the art will recognize that there are other resources that can be registered in a similar fashion. For example, the resource registered may be a service to retrieve email from a specific mailbox; in that case, the registrant 141, will provide the email address, email server location, password together with other email related information to be associated with an internet independent preexisting unique identifier. And all these information will be stored in the database 150. Furthermore, a set of extensions of the internet-independent, preexisting, unique identifier may be registered together with this unique identifier in the database 150 during the registration. Each extension may also be associated with a different resource/services. In the meantime, the network resource management center 120 setup a network-resource request input means, which is part of the request processor 105, that may be an HTTP server or a mail server capable of processing the Simple Mail Transfer Protocol (SMTP) request or Post-Office Protocol (POP) requests. These servers is provided to receive from a network resource requester 130 a network-resource request-input such as an HTTP input or a SMTP/POP electronic mail (e-mail) input. When network resource requester 130 sends in the resource request by HTTP command, the URL of the HTTP command includes the location information of the request processor 105 and the Internet-independent preexisting-unique identifier. Such identifier may be the telephone number associated with the web page stored on server 140; again, the close couple between the telephone number and the web page on server 140 is only exemplary and not necessary the only identifier that may be useful. As described above, the network resource requester 130 may enter this Internet-independent preexisting-unique identifier with some degrees of flexibility. For example, the telephone number may be entered with or without a prefix “1” for a long distance number or may even be entered without an area code if it is a local number for the network resource requester 130 or may be entered as a string of mixed alphanumeric or may be entered as numbers separated by hyphens; again, the examples here are exemplary and not intended to be limiting. The network-resource request processor 105 can then normalizes and converts the Internet-independent preexisting-unique identifier input into a normalized network-resource request to carry out a database search for finding out the associated stored program and/or their parameter, in one implementation, this stored program may be an URL forwarder 101 with associated URL.

As that disclosed in FIGS. 1 and 2, this invention discloses a network system 100. The network system includes a network resource management center 120 comprises a database 150 for storing paired data for linking a network-independent preexisting-unique identifier and/or its set of extensions to their respective stored program and parameters 152 to carry out the intent of the request; one type of stored program may be a URL forwarding service with a URL as its parameter. In a preferred embodiment, the network resource management center 120 further comprises a network-resource request-input processor 105 for processing a network-resource request input comprises information related to the network-independent preexisting-unique identifier for searching the database 150 for providing a linked stored program stored in the database 150. In a preferred embodiment, the network resource management center 120 further comprises a network-resource registration processor 106 for receiving a registration request comprises a network-independent preexisting-unique identifier and an associated stored program and/or their parameters for storing in the database. In the case the intent is to forward a URL then a URL is stored in the database. In a preferred embodiment, the network-resource request-input processor further comprises a network-resource request-input normalizing means for normalizing and converting a network-resource request-input into a normalized network-resource request. In a preferred embodiment, the network-resource request-input processor further comprises a first sub-domain processing means for receiving and processing a network-resource request-input constituting a first sub-domain name under an Internet domain name of the request processor 105 of the network resource management center 120. A network-resource request-input may be www.RequestProcessor105.com/FirstSubDomainName if HTTP is used or FirstSubDomainName@RequestProcessor105.com if SMTP or POP protocol are used. In a preferred embodiment, the Internet independent, preexisting, unique identifier, e.g., a phone number, or its derivatives is used as the FirstSubDomainName in the above examples. One specific example may be www.webattel.com/6505551212 is implemented as an URL for directory service to find out telephone numbers having an area code of (650) where webattel is an exemplary web-site for hosting the network resource management center 120. In a preferred embodiment, the network resource management center 120 further comprises a request-intent processor 165 to call upon different stored program to carry out the intent of the request from requester 130. In the case where the intent of the request is to forward URL then an URL forward means 110 is invoked for forwarding an URL retrieved from the database to a network resource requester 130.

According to FIGS. 1 and 2, this invention discloses a method for generating a uniform resource locator (URL) for linking a network resource requester 130 to a target Web resource on network server 140. The method comprising steps of a) the Internet user 130 providing an user-input which includes an Internet-independent preexisting unique identifier related to the target Web resource on network server 140 to a request processor 105 of the network resource management center 120; and b) the request processor 105 searches a database 150 to find a stored program and an URL corresponding to an Internet-independent unique identifier for generating the URL for linking the network resource requester 130 to the target Web resource on network server 140. In a preferred embodiment, the step a) of the Internet user 130 providing a user-input Internet-independent preexisting unique identifier is a step a1) of the Internet user 130 providing the user-input Internet-independent preexisting unique identifier as a first sub-field following an Internet domain name of the request processor 105 of the network resource management center 120. In a preferred embodiment, the step b) further comprising a step b1) of the request processor 105 converting the user-input Internet-independent preexisting unique identifier to a normalized Internet-independent preexisting unique identifier associated with the target Web resource on network server 140 for the request processor 105 to search a database 150 to find an URL corresponding to the normalized Internet-independent unique identifier for generating the URL for linking the Internet user 130 to the target Web resource on network server 140. In an actual implementation of this invention, the normalization could also be included as part of the exception handling process for searching database when a match can not be found after the database search is completed. In a preferred embodiment, the step a) of the Internet user providing a user-input Internet-independent preexisting unique identifier is a step a2) of the Internet user providing the user-input Internet-independent unique identifier as a telephone number corresponding to the target Web resource on network server 140. In a preferred embodiment, the step a2) of the Internet user 130 providing the user-input Internet-independent unique identifier as a telephone number corresponding to the target Web resource is a step a3) of inputting the telephone number as a first sub-field following an Internet domain name of the control Web site of the request processor 105 in network resource management center 120. In a preferred embodiment, the step a) of the Internet user providing a user-input Internet-independent unique identifier is a step a4) of the Internet user providing the user-input Internet-independent unique identifier as a advertisement identifier number corresponding to the target Web resource. In a preferred embodiment, the step a4) of the Internet user providing the user-input Internet-independent unique identifier as an advertisement identifier number corresponding to the target Web resource is a step a5) of inputting the advertisement identifier number as a first sub-field following an Internet domain name of the control Web site. In a preferred embodiment, the step a) of the Internet user providing a user-input Internet-independent unique identifier is a step a6) of the Internet user providing the user-input Internet-independent unique identifier as a branch location name and/or GPS coordinates corresponding to the target Web page. In a preferred embodiment, the step a6) of the Internet user providing the user-input Internet-independent unique identifier as an branch location name and or GPS coordinates corresponding to the target Web page is a step a7) of inputting the branch location name and/or GPS coordinates as a first sub-field following an Internet domain name of the control Web site. All above descriptions are about web resource/page access, actual implementation can also include mail application such as inputting the telephone number as the user name part of an email address e.g., FirstSubDomainName@RequestProcessor105.com

In summary, this invention discloses a network system comprises a network resource management center 120 provided with an interactive database 150 for enabling an owner of a internet-independent, preexisting unique identifier to editing this unique identifier or number and/or its extensions with its linking pointer for linking to their respective network resource which could be any stored program.

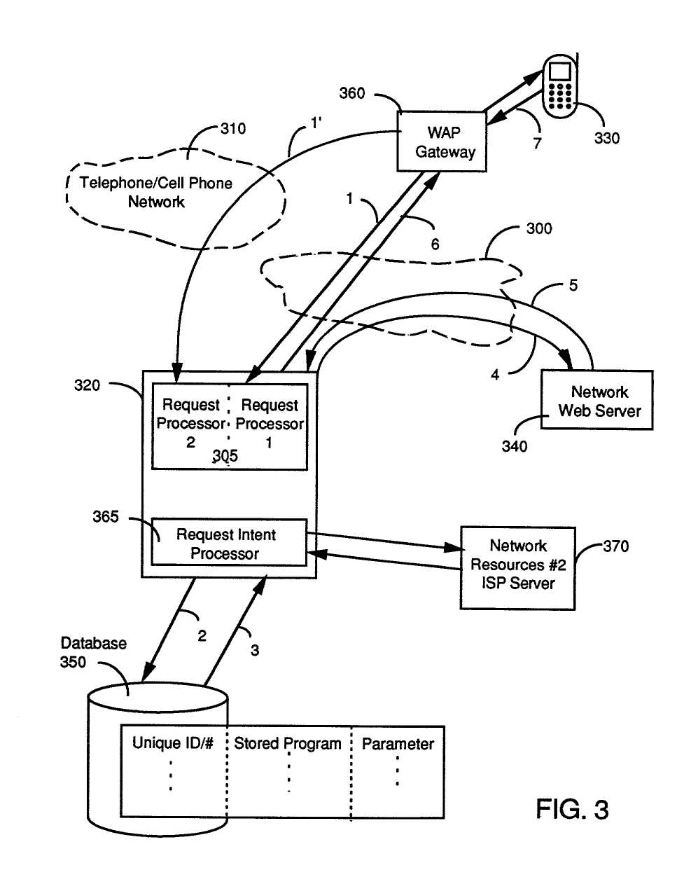

Referring to FIG. 3 for a functional block diagram showing an architecture overview of another system configuration of this invention. The network communication system, e.g., an Internet system 300 and a telephone and mobile phone network 301, includes a network resource management center 320. In one of the preferred embodiments, this network resource management center 320 can be implemented as an Internet Web server. The network resource management center 320 is connected to and in communication with a wireless network resource requester 330, e.g., a wireless Internet telephone user via the Internet 300. The wireless Internet telephone user 330 is communicating with the Internet system 300 via a wireless application protocol (WAP) gateway 360 for transmitting a network resource request input such as an HTTP request, i.e., step (1), for a registered network resource. The requested network resource may be a Web page stored in network server 340. The network resource management center 320 includes a network resource request processor 305 and a request-intent processor 365. The wireless-network-resource requester 330 sends a network-resource request-input to the request processor 305 through the WAP gateway 360 via the Internet 300. The wireless network-resource request-input may preferably include an Internet-independent unique preexisting identifier such as a specific telephone number, i.e., step (1′). This telephone number may be one of the numbers already stored as a “speedy dialing number” such that the wireless network-resource requester 330 can simply push one button to send out the request. The network-independent identifier may be an identifier to identify and link to an Internet Web resource stored on network server 340, e.g., a requester's Charles Schwab Stock Profile management page, that has an unique association with the Internet-independent preexisting identifier such as an (800) free-access phone number. A wireless telephone user with features to access the Internet can access his/her own broker account by pushing a few speedy dial buttons. Alternatively, the network requester 330 may send the network-resource request input from a micro-browser via the WAP to retrieve a Web page of map with the GPS data of the location of the requester 330. The resource request processor 305 further includes a request-input normalization logic that could be implemented as software or a hardware component of the network-resource request processor 305. After the network resource management center 320 receives the network-resource request-input, the network-resource request processor performs a normalization to convert the request-input into a normalized network resource request. Then the network resource request processor 305 accesses a network resource database 350, i.e., step (2), to perform a database search to match the normalized network-resource request with a uniform resource locator (URL), or a set of stored program and parameters. Normalization can also be part of the exception handling process for database lookup when a matching can not be found. If the normalized network-resource request is matched to a simple uniform resource locator (URL), i.e., step (3), the matched URL is forwarded to the wireless network-resource requester 330, i.e., steps (6), and (7). Using that matched URL, the wireless network-resource requester 330 is linked to the web page stored on network server 340, which can be easily associated with the network-resource request-input that is uniquely designated with an Internet-independent preexisting identifier such as a telephone number. In stead of forwarding this URL to the requester 330, a stored program can also be used to retrieve information from server 340, i.e., steps (4) and (5), repackaging the information to make it easier to be displayed on the requester 's micro-browser.

As an option, the normalized network-request converted from the network-resource request-input, associated with an network-independent unique preexisting identifier, may also link to a set of stored programs and related parameters for performing different functions. These stored programs may involve functions such as log into an e-mail address, e.g., network-resource #2 managed by a internet service provider (ISP) server 370, to retrieve electronic mails, or check a voice mail to retrieve the phone messages. The network resource management center 320 further includes a request-intent processor 365 to understand the request, and to invoke and execute the stored programs with related parameters. The request-intent processor 365 may also be used for obtaining network-resource request output-data for forwarding to the wireless network-resource requester 330.

Referring to FIG. 3 for a functional block diagram showing an architecture overview of yet another system configuration of this invention. The network communication system, e.g., an Internet system 300, a telephone and mobile phone network 301, includes a network resource management center 320. In one of the preferred embodiments, this network resource management center 320 can be implemented as having a request processor 305 that communicate with the resources requester 330 through the telephone/mobile phone network 301. The resource requester 330 makes a call to the request-processor and punch in a telephone number and/or extension numbers that have been previously registered. The request processor 305 will search the database 350 to find the associated stored program and the request-intent processor 365 invokes the stored program. If the output of a resource request needs to be sent back to the requester through internet system 300 and WAP gateway, then the request-intent processor 365 will figure out the path to reach requester 330 over internet system 300. One way of finding out the path to 330 is by inquiring WAP gateway with the mobile phone number of 330 which we had when 330 was making the resource request. Another option is to have 330 access the network resource management center 320 through 360 and 300 to register its calling phone number and the internet path to reach it.

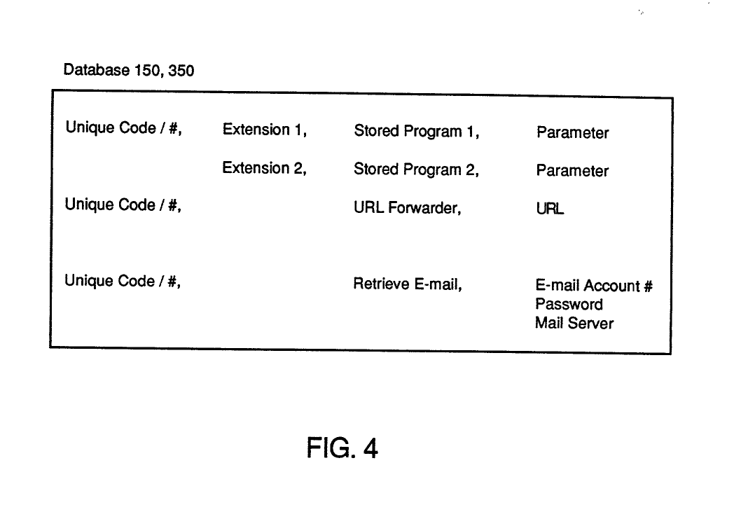

Referring to FIG. 4 for a preferred embodiment in implementing the database 150 of FIG. 1. or the database 350 of FIG. 3. The first column of the data entries lists an internet-independent preexisting unique identifier that may be a code or a number. In one implementation of the present invention; associated with each unique identifier are an URL, and/or other parameters. In another implementation of the present invention, associated with each unique identifier are an e-mail address and other account information for retrieving the e-mails. In another implementation of the present invention, for each of the Internet-independent unique identifier, an set of extensions may also be registered. Each extension in the database is associated with a specific stored program for execution particular functions with the parameters provided in the database. The stored program may include functions such as retrieve a map for the GPS data provided as part of the network-resource request-input. The stored program may be invoked to display an account information or stock quotes from a stock broker, send a pager message to a particular number, send a signal home to networked appliances to turn on the lights, the heater or security monitoring system. By applying a single unique identifier provided with several extension code, a network-resource requester is enabled to perform many different functions conveniently without requiring to manipulate the input devices to enter long list of program invocation commands and parameters for each program executions. All information in database, including Internet independent preexisting unique identifier, extension, stored program/services are all collected during the registration process. In one implementation of the present invention, When the network-resource management center received a network-resource request from the network Web browser, the associated URL is sent back to the requester. In another implementation of the present invention, When the network-resource management center received a network-resource request in the form of SMTP or POP request, the e-mails from the accounts provided in the database are retrieved and sent back to the requester.

The network resource-management center as described above can provide several types of server to carry out the registration, to process HTTP, telephone, SMTP or POP based network-resource request-input, and to invoke and process stored programs using the store parameters or parameter provided, directly or indirectly, by the resource request input. In the implementation where HTTP is used as the protocol by the request processor 105 and/or registration processor 106 in the network resource management center 120, the registration process can be implemented using forms on the web pages. The request processor 105 processes a network resources request coming in from a browser, in this case a control web server. Stored program can be invoked by CGI (common gateway interface) program or Java servlets based on the incoming HTTP request. In the implementation where SMTP and/or POP are used by the registration processor 106 and/or request processor 105 as the protocol for the resource management center, the registration can be implemented, using resource management center mail server, by processing registration email and compile information needed for the database. Network service request, coming in using SMTP protocol can be stored in a specific mailbox first and then have another program to process the registration request and build the database 150. Network service request, coming in using POP protocol can retrieve information that has been stored in a specific mailbox . A network resource management center can also choose to use all protocols or mix and match different protocols for registration processor, resource request processor, request-intent processor and stored program execution.

The network-resource management center is also provided to interface with different kinds of network-resource requesters such as an Internet Web browser, an Internet mail program such as Outlook program, a wireless device running micro-browser, and other types of requester's network-resource request-inputs.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A method for generating an universal resource locator (URL) for linking an Internet User to a target Web page comprising:
a) said Internet user providing an user-input Internet-independent unique identifier related to said target Web page to a control Web site; and
b) said control Web site searches a database to find an URL corresponding to an Internet-independent unique identifier for generating said URL for linking said Internet user to said target Web page.

2. The method of claim 1 wherein:
said step a) of said Internet user providing a user-input Internet-independent unique identifier is a step a1) of said Internet user providing said user-input Internet-independent unique identifier as a first sub-field following an Internet domain name of said control Web site.

3. The method of claim 1 wherein:
said step b) further comprising a step b1) of said control Web site converting said user-input Internet-independent unique identifier to a normalized Internet-Independent unique identifier of said target Web page for said control Web site to search a database to find an URL corresponding to said normalized Internet-independent unique identifier for generating said URL for linking said Internet user to said target Web page.

4. The method of claim 1 wherein:
said step a) of said Internet user providing a user-input Internet-independent unique identifier is a step a2) of said Internet user providing said user-input Internet-independent unique identifier as a telephone number corresponding to said target Web page.

5. The method of claim 4 wherein:
said step a2) of said Internet user providing said user-input Internet-independent unique identifier as a telephone number corresponding to said target Web page is a step a3) of inputting said telephone number as a first sub-field following an Internet domain name of said control Web site.

6. The method of claim 1 wherein:
said step a) of said Internet user providing a user-input Internet-independent unique identifier is a step a4) of said Internet user providing said user-input Internet-independent unique identifier as a advertisement identifier number corresponding to said target Web page.

7. The method of claim 6 wherein:
said step a4) of said Internet user providing said user-input Internet-independent unique identifier as an advertisement identifier number corresponding to said target Web page is a step a5) of inputting said advertisement identifier number as a first sub-field following an Internet domain name of said control Web site.

8. The method of claim 1 wherein:
said step a) of said Internet user providing a user-input Internet-independent unique identifier is a step a6) of said Internet user providing said user-input Internet-independent unique identifier as a branch location name corresponding to said target Web page.

9. The method of claim 8 wherein:
said step a6) of said Internet user providing said user-input Internet-independent unique identifier as an branch location name corresponding to said target Web page is a step a7) of inputting said branch location name as a first sub-field following an Internet domain name of said control Web site.

10. A network system comprising:
a network resource management center comprising a database for storing paired data for linking a network-independent preexisting-unique identifier to a network resource locator.

11. The network system of claim 10 wherein:
said network resource management center further comprising a network-resource request-input processor for processing a network-resource request input comprising information related to said network-independent preexisting-unique identifier for searching said database for providing a linked URL stored in said database.

12. The network system of claim 10 wherein:
said network resource management center further comprising a network-resource registration processor for receiving a registration request comprising a network-independent preexisting-unique identifier and an associated network resource locator for storing in said database.

13. The network system of claim 11 wherein:
said network-resource request-input processor further comprising a network-resource request-input normalizing means for normalizing and converting a network-resource request-input into a normalized network-resource request.

14. The network system of claim 11 wherein:
said network-resource request-input processor further comprising a first sub-domain processing means for receiving and processing a network-resource request-input constituting a first sub-domain name under an Internet domain name of said network resource management center.

15. The network system of claim 10 further comprising:
an universal resource locator forward means for forwarding an universal resource locator retrieved from said database to a network resource requester.

16. A network system comprising:
a network resource management center provided with an interactive database for enabling an owner of a network resource to editing an unique linking pointer for linking to said network resource.
